(19) United States
(12) Patent Application Publication
(10) Pub. No.: US 2007/0135059 A1
(43) Pub. Date: Jun. 14, 2007

(54) Apparatus and method for acquiring channel state information in a wireless relay network

(75) Inventors: Hiroyuki Yomo, Aalborg (DK); Elisabeth De Carvalho, Aalborg (DK); Petar Popovski, Aalborg (DK); Jae-Hyuk Jang, Deagu (KR); Eun-Taek Lim, Suwon-si (KR); Young-Kwon Cho, Suwon-si (KR); Dong-Seek Park, Yongin-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/638,074

(22) Filed: Dec. 13, 2006

(30) Foreign Application Priority Data
Dec. 13, 2005 (KR) 2005-0122261

(51) Int. Cl. H04B 7/00

(52) U.S. Cl. 455/69; 370/318; 455/522

(57) ABSTRACT

An apparatus and a method for estimating the channel state of each link in a wireless relay network having fixed RSs are provided. A source estimates a channel of a source-RS link and a channel of a source-destination link using pilot signals received from an Relay Station (RS) and a destination and the source monitors reception of a pilot signal including channel state information of an RS-destination link from the RS. Upon receipt of the pilot signal, the source estimates a channel of the RS-destination link using the pilot signal and the channel state information of the RS-destination link.

### PRIORITY

This application claims priority under 35 U.S.C. § 119 to an application entitled “Apparatus And Method For Acquiring Channel State Information In A Wireless Relay Network” filed in the Korean Intellectual Property Office on Dec. 13, 2005 and assigned Serial No. 2005-122261, the contents of which are incorporated herein by reference.

### BACKGROUND OF THE INVENTION

1. Field of the Invention

The present invention relates generally to a wireless relay network, and in particular, to an apparatus and method for acquiring information about channel states among a Base Station (BS), a Relay Station (RS), and a Mobile Station (MS) over a wireless relay network.

2. Description of the Related Art There is ongoing research to build a self-configurable wireless network, which is one of the most critical requirements for deployment of a 4^{th} Generation (4G) mobile communication system.

The self-configurable wireless network refers to a wireless network configured in an autonomous or distributed manner without control of a central system to provide mobile communication services. For the 4G mobile communication system, cells of very small radiuses are defined for the purpose of enabling high-speed communications and accommodating a larger number of calls. In this case, conventional centralized wireless network design is not easible. Rather, the wireless network should be built to be under distributed control and to actively cope with an environmental change like additional installation of new BSs. Hence, the 4G mobile communication system requires a self-configurable wireless network configuration.

For real deployment of the self-configurable wireless network, techniques used for an ad hoc network must be introduced to the mobile communication system. A major example of the self-configurable wireless network is a wireless relay network configured by applying a relay scheme used for the ad hoc network to a network with fixed BSs.

Generally, since a BS and an MS communicate with each other via a direct link in the cellular network, a highly reliable wireless communication link can be easily established between them.

However, due to the fixedness of BSs, the configuration of the wireless network is not flexible, thereby making it difficult to provide an efficient service in a wireless environment experiencing a fluctuating traffic distribution and a great change in the number of requested calls.

A relay scheme of delivering data over multiple hops using a plurality of neighbor MSs or neighbor RSs can overcome such a drawback. This relay scheme facilitates fast network reconfiguration adaptive to an environmental change and renders the overall wireless network operation efficient. Also, a radio channel with better quality can be provided to an MS by installing an RS between the BS and the MS and thus, establishing a multi-hop relay path via the RS. Since high-speed data channels can be provided to MSs in a shadowing area or an area where communications with the BS are unavailable, cell coverage is expanded.

FIG. 1 illustrates the configuration of a typical wireless relay network. Referring to FIG. 1, an MS 110 within the service area 101 of a BS 100 is connected to the BS 100 via a direct link. Alternatively, an MS 120, which is located outside the service area 101 of the BS 100 and thus in a poor channel state, communicates with the BS 100 via a relay link of an RS 130.

The RS 130 provides a better-quality radio channel to the MS 120 when it is located outside of the service area 101 of the BS 100 or in a shadowing area experiencing the severe shielding effects of buildings. Thus, the BS 100 can provide a high-speed data channel to the cell boundary area in a poor channel state using a multi-hop relay scheme and thereby expand its cell coverage.

FIG. 2 illustrates data flows in the typical wireless relay network. As illustrated in FIG. 2, there are three kinds of links when services are provided via the RS over the wireless relay network. Referring to FIG. 2, a Source-RS (SR) link 211, an RS-Destination (RD) link 213, and a Source-Destination (SD) link 215 exist in the wireless relay network. The links 211, 213 and 215 all use independent and different channels. Also, the channels change in time.

In the case of transmitting data from a BS to MSs, with knowledge of the channel state of each link, the BS selects a link in a good channel state and transmits data to the MS of the link. Also, the BS 205 can transmit data in an Adaptive Modulation and Coding (AMC) scheme according to the channel states of links.

As described above, if the source is aware of the channel state information of each link, it can adaptively transmit data according to the channel state of the link in the wireless relay network.

Conventionally, the BS collects the channel state information of the links, i.e. the channel state information of the SD, SR and RD links from feedback information from the RS and the MS. The BS then schedules data to be transmitted via the links, considering their channel states.

However, the feedback of the channel state information of the links takes a large volume of resources. A Time Division Duplex (TDD) system saves resources based on channel reciprocity. Relying on the idea that channel state information is similar for the downlink and the uplink, where a downlink signal is estimated by utilizing an uplink signal. For example, the BS estimates the channel state information of the SR and SD links by measuring the strengths of uplink signals received from the RS and the MS. Yet, when the TDD system supports a relay service, the BS cannot receive a signal from the RD link. Thus, it follows that either the RS or the MS feeds back the channel state information of the RD link to the BS.

### SUMMARY OF THE INVENTION

An object of the present invention is to substantially solve at least the above problems and/or disadvantages and to provide at least the advantages described below. Accordingly, an object of the present invention is to provide an apparatus and method for acquiring information about channel states among a source, an RS and a destination over a wireless relay network in the source.

Another object of the present invention is to provide an apparatus and method for acquiring information about channel states among a source, an RS and a destination over a wireless relay network without feedback signals in the source.

A further object of the present invention is to provide an apparatus and method for acquiring information about channel states among a source, an RS and a destination using pilot signals over a wireless relay network in the source.

The above objects are achieved by providing an apparatus and a method for estimating the channel state of each link in a wireless relay network having fixed RSs.

According to one aspect of the present invention, there is provided a method of estimating channel states in a source in a wireless relay network having fixed RSs. The source estimates a channel of a source-RS link and a channel of a source-destination link using pilot signals received from an RS and a destination and the source monitors reception of a pilot signal including channel state information of an RS-destination link from the RS. Upon receipt of the pilot signal, the source estimates a channel of the RS-destination link using the pilot signal and the channel state information of the RS-destination link.

According to another aspect of the present invention, there is provided in a source apparatus for channel state estimation in a wireless relay network having fixed RSs, a demultiplexer for extracting a pilot signal from a signal received through an antenna, and a channel estimator for estimating a channel of an RS-destination link using a pilot signal received from an RS.

According to a further aspect of the present invention, there is provided in an operation method in an RS, for channel state estimation in a source in a wireless relay network having fixed RSs, the RS estimates a channel of an RS-destination link using a pilot signal received from a destination. The RS controls the transmit power of a pilot signal to be transmitted to the source based on channel state information of the RS-destination link and transmits the power-controlled pilot signal to the source.

According to still another aspect of the present invention, there is provided in an RS apparatus for channel state estimation in a source in a wireless relay network having fixed RSs, a pilot signal generator for generating a pilot signal to be transmitted to the source. A pilot power controller controls the transmit power of the pilot signal using channel state information of an RS-destination link. An encoder for encodes and modulates transmission data for the source at a coding rate and in a modulation scheme. A multiplexer generates a transmission signal by multiplexing the coded and modulated data with the power-controlled pilot signal.

### BRIEF DESCRIPTION OF THE DRAWINGS

The above and other objects, features and advantages of the present invention will become more apparent from the following detailed description when taken in conjunction with the accompanying drawings in which:

FIG. 1 is a diagram illustrating a configuration of multiple links in a typical wireless relay network;

FIG. 2 is a diagram illustrating data flows in a typical wireless relay network;

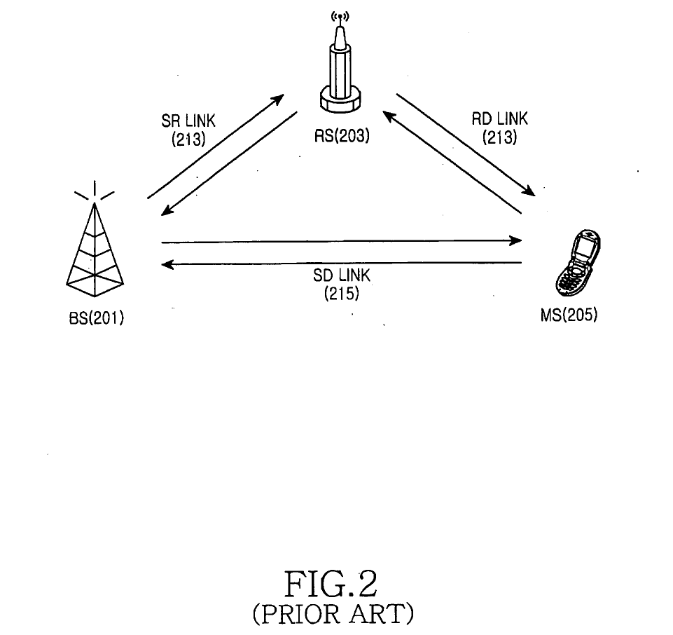

FIG. 3 is a ladder diagram illustrating a signal flow for an operation for acquiring information about channel states among a source, an Relay Station (RS) and a destination in a wireless relay network according to the present invention;

FIG. 4 is a flowchart illustrating an operation for providing the channel state information of an RS-Destination (RD) link to a source in an RS in the wireless relay network according to the present invention;

FIG. 5 is a flowchart illustrating an operation for estimating the channel of the RD link in the source in the wireless relay network according to the present invention;

FIG. 6 is a block diagram illustrating a transceiver in the wireless relay network according to the present invention; and

FIG. 7 is a block diagram illustrating a source receiver in the wireless relay network according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

The present invention is intended to provide a technique for acquiring information about channel states among a source, an RS and a destination using pilot signals in the source in a wireless relay network. It is assumed herein that the source is a BS, the destination is an MS, and the RS is fixed, experiencing less changes in the channel between the BS and the RS.

While the present invention will be described in the context of an Orthogonal Frequency Division Multiple Access-Time Division Duplex (OFDMA-TDD) wireless communication system, it is understood that the present invention is also applicable to any relay communication system. Hereinafter, a BS-RS link, a BS-MS link, and an RS-MS link will be respectively referred to as an Source-RS (SR) link, an Source-Destination (SD) link, and an RS-Destination (RD) link.

A description, by way of example, will be made herein of estimation of the channels of the SD link, the SR link, and the RD links in the BS. The channel estimation can be performed in the same manner in the RS.

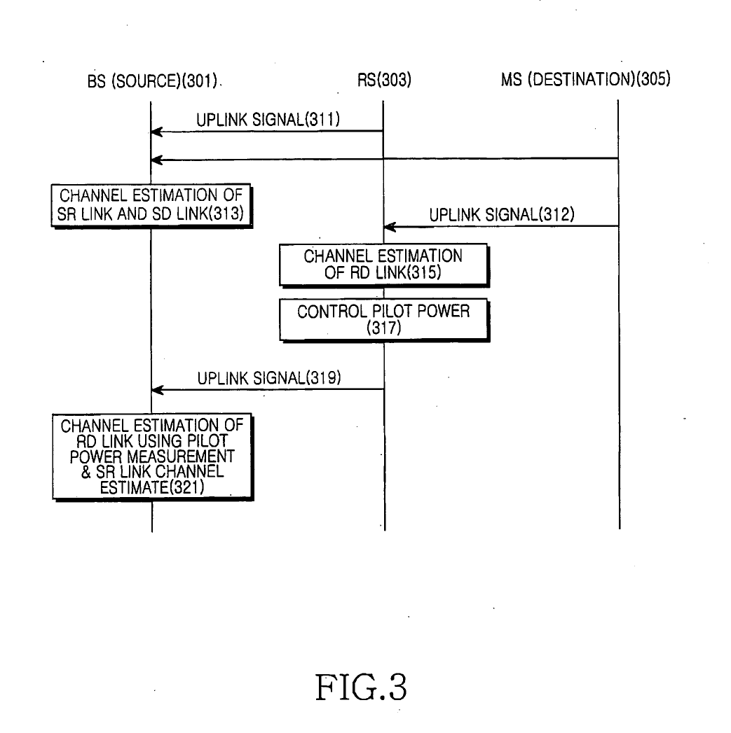

FIG. 3 is a ladder diagram illustrating a signal flow for an operation for acquiring information about channel states among a source, an RS and a destination in a wireless relay network according to the present invention.

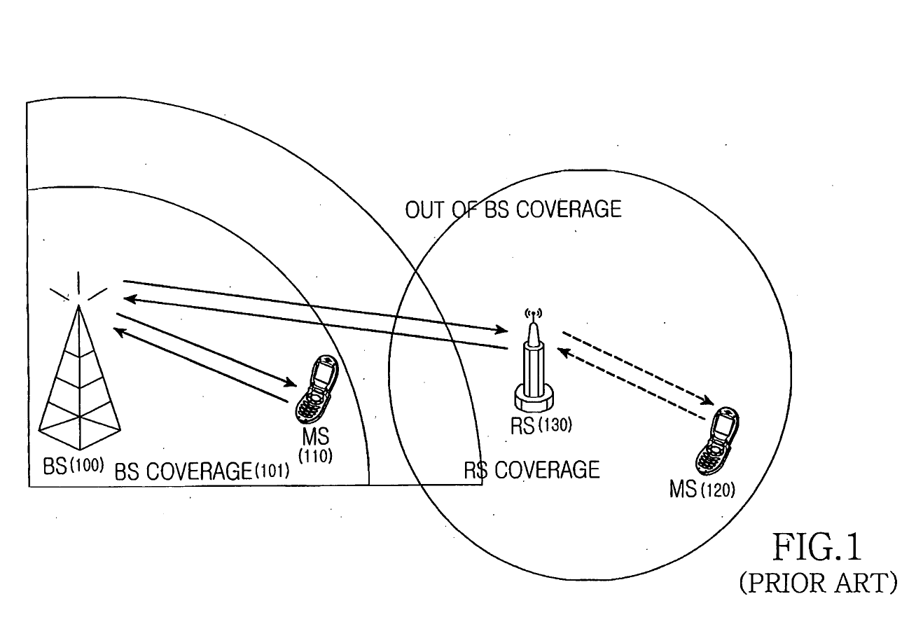

Referring to FIG. 1, in step 311 a BS 301 monitors reception of uplink signals from an RS 303 and an MS 305. Upon receipt of the uplink signals, in step 313 the BS 301 estimates the channels of an SD link and an SR link using pilot signals included in the received signals. That is, the RS 303 and the MS 305 have transmitted the uplink signals including pilot signals with predetermined power according to control messages. The BS 301, having knowledge of the power of the pilot signals, can estimate the channels of the SD link and the SR link using the received power of the pilot signals.

Upon receipt of an uplink signal from the MS 305 in step 312, the RS 303 estimates the channel of an RD link using a pilot signal included in the uplink signal in step 315.

The RS 303 controls the power of a pilot signal using the received power of the pilot signal received from the MS 305 in order to transmitted channel state information of the RD link in step 317.

In step 319, the RS 303 transmits the power-controlled pilot signal to the BS 301. Since the SR link changes minimally due to the fixedness of the RS 303, the transmission period of the pilot signal transmitted from the RS 303 to the BS 301 for SR link estimation can be lengthened. In other words, the RS 303 transmits the pilot signal at a predetermined power level to the BS every predetermined period, for channel estimation of the SR link. Between transmission periods, the RS 303 transmits the pilot signal whose power is controlled according to the channel state information of the RD link.

The BS 301 measures the received power of the pilot signal from the RS 303 and estimates the channel of the RD link using the pilot power measurement and the channel estimate of the SR link in step 321.

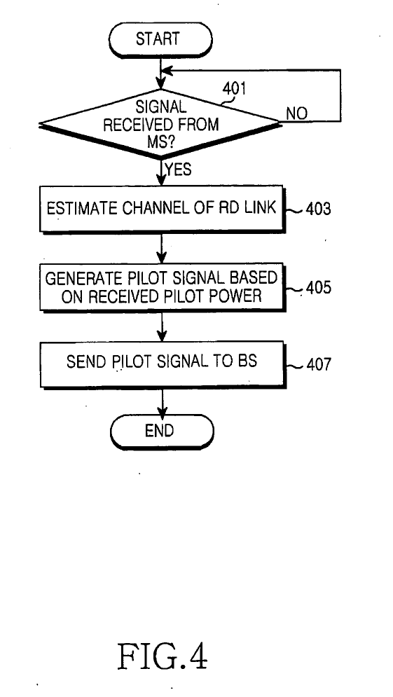

FIG. 4 is a flowchart illustrating an operation for providing the channel state information of the RD link to the source in the RS in the wireless relay network according to the present invention. This operation concerns generating a pilot signal including the channel state information of the RD link and transmits it to the BS 301 in the RS 303 of FIG. 3 so that the BS 301 can estimate the channel of the RD link. The pilot signal carrying the channel state information of the RD link is not the pilot signal transmitted to the BS for channel estimation of the SR link every predetermined period.

Referring to FIG. 4, in step 401 the RS monitors reception of an uplink signal from the MS.

Upon receipt of the uplink signal, in step 403 the RS estimates the channel of the RD link using a pilot signal included in the uplink signal. The received power of the pilot signal is given as set forth in Equation (1) below:
P_{R}_{_{—}}_{Relay}=P_{Pilot}|h_{RD}ⁱ|² (1)
where P_{R}_{_{—}}_{Relay} denotes the received pilot power, P_{Pilot} denotes the power of the pilot signal transmitted by the MS, and h_{RD}ⁱ denotes the channel coefficient of the RD link. Here, i denotes a subcarrier index in the OFDMA communication system or a carrier index in a Multi Carrier-Code Division Multiple Access (MC-CDMA) communication system.

The received pilot power results as the transmit power of the pilot signal from the MS experiences the channel of the RD link. The RS, with knowledge of the transmit pilot power of the MS, can estimate the channel of the RD link. The transmit power pilot of the MS is known to the RS by a system information message.

In step 405, the RS generates a pilot signal carrying the channel state information of the RD link. Since the received pilot power provides the channel state information of the RD link, the RS controls the power of the pilot signal using the received pilot power. For example, the RS generates a pilot signal with the received pilot power. Also, the RS determines the transmit power of the pilot signal based on the received pilot power and the channel power of the SR link by Equation (2) as expressed below. The channel power of the SR link is acquired by estimating the SR link using a downlink signal in the RS. Since channel characteristics are identical on the downlink and uplink channels in the TDD system, the RS estimates the SR link using the downlink signal.
P_{T}_{_{—}}_{Relay}=P_{R}_{_{—}}_{Relay}/|h_{SR}ⁱ|² (2)
where P_{T}_{_{—}}_{Relay} denotes the transmit pilot power of the RS, P_{R}_{_{—}}_{Relay} denotes the received pilot power from the MS, and h_{SR}ⁱ denotes the channel coefficient of the SR link.

Then the RS transmits an uplink signal including the generated pilot signal to the BS in step 407. The RS terminates the algorithm of the present invention.

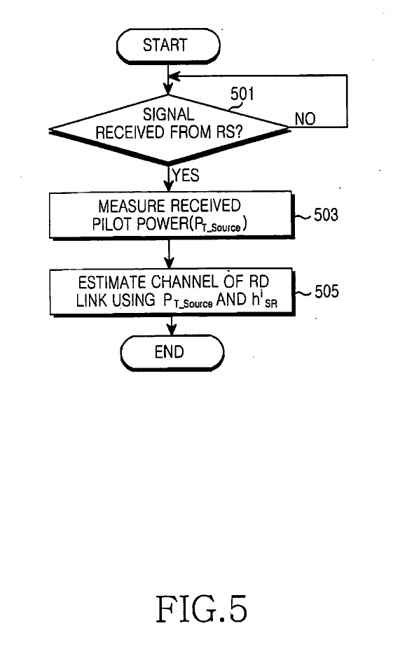

FIG. 5 is a flowchart illustrating an operation for estimating the channel of the RD link in the source in the wireless relay network according to the present invention. This operation concerns the channel estimation of the RD link in step 321 of FIG. 3.

Referring to FIG. 5, in step 501 the BS monitors reception of an uplink signal from the RS. Upon receipt of the uplink signal, in step 503 the BS measures the power of a pilot signal included in the received signal.

In step 505, the BS estimates the channel of the RD link using the pilot power measurement and a channel estimate of the SR link. For example, when the RS transmits the pilot signal with power calculated according to Equation (2), the received pilot power of the BS is given by Equation (3),

$${P}_{R\_Source} = {P}_{T\_Relay} {\vert {h}_{SR}^{i} \vert}^{2} = {P}_{R\_Relay} = {P}_{Pilot} {\vert {h}_{SR}^{i} \vert}^{2} \qquad ( 3 )$$

where P_{R}_{_{—}}_{Source} denotes the received pilot power of the BS, P_{T}_{_{—}}_{Relay} denotes the transmit pilot power of the RS, h_{SR}ⁱ denotes the channel coefficient of the SR link, P_{R}_{_{—}}_{Relay} denotes the received pilot power of the RS from the MS, h_{RD}ⁱ denotes the channel coefficient of the RD link, and P_{Pilot} denotes the transmit pilot power of the MS.

When the RS transmits a pilot signal at a power level computed using Equation (2), i.e.

$${P}_{T\_Relay} = {P}_{R\_Relay} / {\vert {h}_{SR}^{i} \vert}^{2}$$

to the BS on the SR link, the BS receives the pilot signal with the received power of a pilot signal that the RS has received from the MS as noted from Equation (3). The BS, with knowledge of the transmit pilot power of the MS for the RS, can estimate the channel of the RD link. The transmit pilot power of the MS for the RS is known to the BS by a system information message.

In the case where the RS transmits a pilot signal with a power equal to the received power of the pilot signal from the MS to the BS, the BS receives the pilot signal with a power expressed by Equation (4) below,

$$\begin{matrix}{P}_{R\_Source} = {P}_{T\_Relay} {\vert {h}_{SR}^{i} \vert}^{2} = {P}_{R\_Relay} = {P}_{Pilot} {\vert {h}_{SR}^{i} \vert}^{2} , \\ = {P}_{Pilot} {\vert {h}_{RD}^{i} \vert}^{2} {\vert {h}_{SR}^{i} \vert}^{2}\end{matrix} \qquad ( 4 )$$

where P_{R}_{_{—}}_{Source} denotes the received pilot power of the BS from the RS, P_{T}_{_{—}}_{Relay} denotes the transmit pilot power of the RS to the BS, h_{SR}ⁱ denotes the channel coefficient of the SR link, P_{R}_{_{—}}_{Relay} denotes the received pilot power of the RS from the MS, h_{RD}ⁱ denotes the channel coefficient of the RD link, and P_{Pilot} denotes the transmit pilot power of the MS to the RS.

Equation (4) expresses that the pilot signal received from the RS at the BS is the product of the received pilot power of the RS from the MS and the channel power of the SR link. Therefore, the BS calculates the received pilot power of the RS from the MS by dividing the received pilot power by the channel power of the SR link (|h_{SR}ⁱ|²). The BS, with knowledge of the transmit pilot power of the MS for the RS, can estimate the channel of the RD link. The transmit pilot power of the MS for the RS is known to the BS by a system information message.

The BS then terminates the algorithm of the present invention.

A transceiver for transmitting the channel state information of the RD link to the BS in the RS and an apparatus for estimating the channels of the SR, SD and RD links in the BS will be described below. If the RS acquires the channel state information of the SR, SD and RD links, a transceiver for transmitting the channel state information of the SD link to the RS in the BS and an apparatus for estimating the channels of the SR, SD and RD links in the RS are identical to the transceiver of the RS and the BS apparatus in configuration.

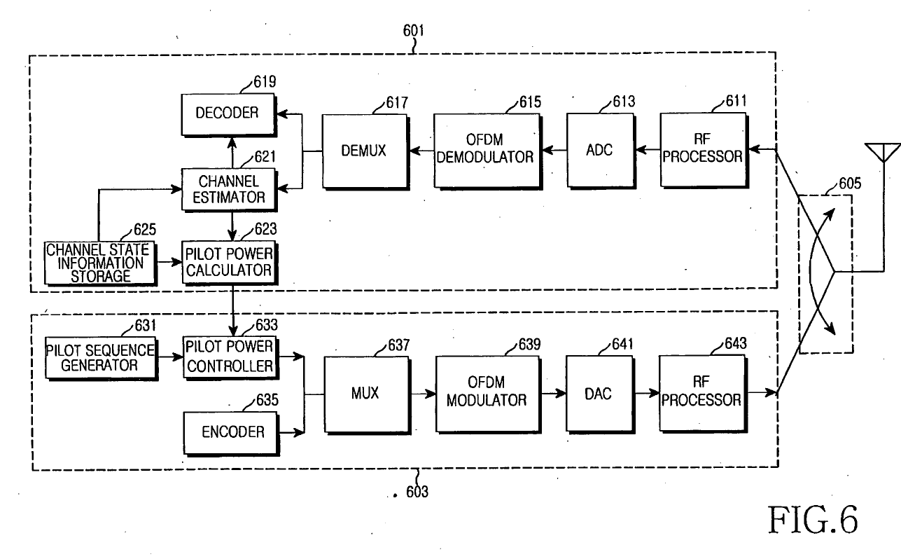

FIG. 6 is a block diagram illustrating the transceiver of the RS in the wireless relay network according to the present invention. The transceiver generates a pilot signal that will carry the channel state information of the RD link to the BS 301 so that the BS 301 can estimate the channel of the RD link. Notably, the RS transmits the channel state information of the RD link to the BS by a pilot signal other than a pilot signal transmitted for channel estimation of the SR link every predetermined period.

Referring to FIG. 6, the RS includes a receiver 601, a transmitter 603, and a Radio Frequency (RF) switch 605.

The RF switch 605 switches in the manner that shares an antenna between the transmitter 603 and the receiver 601. For example, the RF switch 605 switches an RF signal received through the antenna to the receiver 601 in reception mode, and switches an RF signal generated from the transmitter 603 to the antenna in transmission mode.

The receiver 601 includes an RF processor 611, an Analog-to-Digital Converter (ADC) 613, an Orthogonal Frequency Division Multiplexing (OFDM) demodulator 615, a Demultiplexer (DEMUX) 617, a decoder 619, a channel estimator 621, a pilot power calculator 623, and a channel state information storage 625 for acquiring the channel state information of the RD link using a signal received from the MS.

In operation, the RF processor 611 down-converts an RF signal received through the antenna to a baseband signal. The ADC 613 converts the baseband analog signal to a digital signal.

The OFDM demodulator 615 converts the digital time signal received from the ADC 613 to a frequency signal by Fast Fourier Transform (FFT).

The DEMUX 617 demultiplexes the FFT signal into a data stream and a pilot signal.

The decoder 619 decodes the data stream at a predetermined coding rate in accordance with a predetermined demodulation method using a channel estimate of the RD link received from the channel estimator 621.

The channel estimator 621 estimates the channel value of the RD link using the pilot signal.

The pilot power calculator 623 calculates the power of a pilot signal to be transmitted to the BS using the RD link channel value and a channel value of the SR link stored in the channel state information storage 625. For example, the pilot power calculator 623 calculates the transmit pilot power using Equation (2) or calculates the power of a pilot signal received from the MS as the transmit pilot power.

In order to transmit the pilot signal of which the power is controlled according to the channel value of the RD link, the transmitter 603 includes a pilot sequence generator 631, a pilot power controller 633, an encoder 635, a Multiplexer (MUX) 637, an OFDM modulator 639, a Digital-to-Analog Converter (DAC) 641, and an RF processor 643.

In operation, the pilot sequence generator 631 generates a pilot sequence to be transmitted to the BS.

The pilot power controller 633 controls the power of the pilot signal generated from the pilot sequence generator 631. For example, in every predetermined transmission period for channel estimation of the SR link, the pilot power controller 633 controls the power of the pilot signal to a level preset with the BS. Outside the transmission period, the pilot power controller 633 controls the power of the pilot signal to the power calculated by the pilot power calculator 623.

The encoder 635 generates a data stream by encoding transmission information at a predetermined coding rate and in a predetermined modulation scheme.

The MUX 637 multiplexes the pilot signal received from the pilot power controller 633 with the data stream received from the encoder 635.

The OFDM modulator 630 converts the multiplexed signal to a time signal by Inverse Fast Fourier Transform (IFFT).

The DAC 641 converts the digital IFFT signal to an analog signal.

The RF processor 643 up-converts the baseband signal received from the FAC 641 to an RF signal and transmits it to the BS through the antenna.

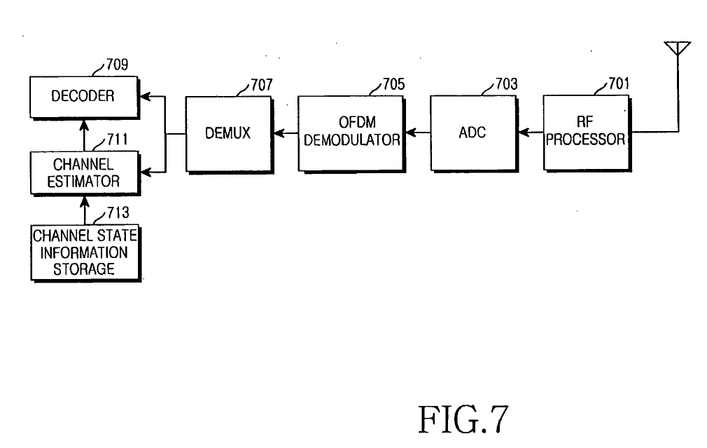

FIG. 7 is a block diagram of a source receiver in the wireless relay network according to the present invention.

Referring to FIG. 7, a receiver in the BS includes an RF processor 701, an ADC 703, an OFDM demodulator 705, a DEMUX 707, a decoder 709, a channel estimator 711, and a channel state information storage 713.

In operation, the RF processor 701 down-converts an RF signal received through the antenna to a baseband signal. The ADC 703 converts the baseband analog signal to a digital signal.

The OFDM demodulator 705 converts the digital time signal received from the ADC 703 to a frequency signal by FFT.

The DEMUX 707 demultiplexes the FFT signal into a data stream and a pilot signal.

The decoder 709 decodes the data stream at a predetermined coding rate in accordance with a predetermined demodulation method using a channel estimate received from the channel estimator 711.

The channel estimator 711 estimates a channel using the pilot signal and channel state information stored in the channel state information storage 713. For example, the channel estimator 711 estimates the channels of the SR link and the SD link using pilot signal received from the MS and the RS.

Meanwhile, the channel estimator 711 estimates the channel of the RD link using a pilot signal received from the RS transmitter illustrated in FIG. 6 and channel state information of the SR link. That is, if the power of the pilot signal received from the RS is given as Equation (3), the channel estimator 711 estimates the channel of the RD link using the power of a pilot signal received at the RS from the MS. If the received pilot power of the BS from the RS is given as Equation (4), the channel estimator 711 estimates the channel of the RD link using the received pilot power of the RS from the MS and the channel state information of the SR link.

While the BS, i.e. the source, estimates the channels of the SD, SR and RD links in the wireless relay network in the above description, if the RS perform the channel estimation on the SD, SR and RD links, instead of the BS, the operation is performed in the same manner. Specifically, the RS estimates the channels of the SR link and the RD link using pilot signals included in signals received from the BS and the MS. Also, the RS estimates the channel of the SD link using a pilot signal carrying the channel state information of the SD link received from the BS.

As described above, the wireless relay network estimates the channel estimate information of each link based on pilot power. The pilot power can be replaced by phase information. If the MS transmits a pilot signal with a predetermined initial phase to the RS, the RS measures the phase of the received pilot signal and transmits a pilot signal whose phase is adjusted based on the received phase to the BS. The BS can detect the phase of the channel of the RD link using the pilot signal received from the RS.

In accordance with the present invention, in the case of using a fixed RS in a wireless relay network, the channel state information of each link is acquired using a pilot signal. The resulting decrease in feedback information saves resources. In addition, signals can be transmitted among the source, the RS and the destination adaptively according to their channel states, using their channel state information.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method of estimating channel states in a source in a wireless relay network having Relay Stations (RSs), comprising the steps of:
estimating states of a channel of a source-RS link and a channel of a source-destination link using pilot signals received from an RS and a destination;
monitoring reception of a pilot signal including channel state information of an RS-destination link from the RS; and
upon receipt of the pilot signal, estimating a state a channel of the RS-destination link using the pilot signal and the channel state information of the RS-destination link.

2. The method of claim 1, wherein estimating the states of the channel of the source-RS link and the channel of the source-destination link comprises:
measuring the received power of the pilot signals from the RS and the destination;
determining the transmit power of the pilot signals from the RS and the destination; and
estimating the states of the channels of the source-RS link and the source-destination link using the received power of the pilot signals and the transmit power of the pilot signals.

3. The method of claim 1, wherein the monitoring step comprises
determining a transmission period of a pilot signal including channel state information of the source-RS link, transmitted by the RS;
determining a transmission period of a pilot signal received from the RS;
determining that the received pilot signal includes the channel state information of the RS-destination link, if the received pilot signal is outside the transmission period of the pilot signal including the channel state information of the source-RS link.

4. The method of claim 1, wherein the pilot signal including the channel state information of the RS-destination link has been subject to power-control according to the channel state information of the RS-destination link.

5. The method of claim 1, wherein estimating the state of the channel of the RS-destination link comprises:
upon receipt of the pilot signal including the channel state information of the RS-destination link from the RS, measuring the received power of the pilot signal;
determining the transmit power of a pilot signal transmitted from the destination to the RS;
estimating the state of the channel of the RS-destination link using the received pilot power and the transmit pilot power, if the RS has generated the pilot signal using the channel state information of the source-RS link.

6. The method of claim 5, wherein the received power of the pilot signal is given by
$${P}_{R\_Source} = {P}_{T\_Relay} {\vert {h}_{SR}^{i} \vert}^{2} = {P}_{R\_Relay} = {P}_{Pilot} {\vert {h}_{SR}^{i} \vert}^{2} ,$$
where P_{R}_{_{—}}_{Source} denotes the received pilot power, P_{T}_{_{—}}_{Relay} denotes the transmit power of the pilot signal transmitted from the RS according to the channel state information of the source-RS link, h_{SR}ⁱ denotes a channel coefficient of the SR link, P_{R}_{_{—}}_{Relay} denotes the received power of the pilot signal received at the RS from the MS, h_{RD}ⁱ denotes a channel coefficient of the RD link, and P_{Pilot} denotes the transmit power of the pilot signal transmitted from the MS to the RS.

7. The method of claim 5, further comprising:
eliminating the channel state information of the source-RS link from the received power of the pilot signal, if the RS has not generated the pilot signal using the channel state information of the source-RS link; and
estimating the channel of the RS-destination link using the power of the pilot signal free of the channel state information of the source-RS link and the transmit power of the pilot signal.

8. The method of claim 7, wherein the received power of the pilot signal is given by
$$\begin{matrix}{P}_{R\_Source} = {P}_{T\_Relay} {\vert {h}_{SR}^{i} \vert}^{2} = {P}_{R\_Relay} = {P}_{Pilot} {\vert {h}_{SR}^{i} \vert}^{2} , \\ = {P}_{Pilot} {\vert {h}_{RD}^{i} \vert}^{2} {\vert {h}_{SR}^{i} \vert}^{2}\end{matrix}$$
where P_{R}_{_{—}}_{Source} denotes the received pilot power, P_{T}_{_{—}}_{Relay} denotes the transmit power of the pilot signal transmitted from the RS to the BS, h_{SR}ⁱ denotes the channel coefficient of the SR link, P_{R}_{_{—}}_{Relay} denotes the received power of the pilot signal at the RS from the MS, h_{RD}ⁱ denotes the channel coefficient of the RD link, and P_{Pilot} denotes the transmit power of the pilot signal transmitted from the MS to the RS.

9. A method in a Relay Station (RS), for channel state estimation in a source in a wireless relay network, comprising the steps of:
estimating a state of a channel of an RS-destination link using a pilot signal received from a destination;
controlling the transmit power of a pilot signal to be transmitted to the source based on channel state information of the RS-destination link; and
transmitting the power-controlled pilot signal to the source.

10. The method of claim 9, wherein the estimating step comprises:
measuring received power of the pilot signal received from the destination;
determining transmit power of the pilot signal transmitted by the destination; and
estimating the state of the channel of the RS-destination link using the received power of the pilot signal and the transmit power of the pilot signal.

11. The method of claim 9, wherein controlling the transmit power comprises:
checking channel state information of a source-RS link; and
controlling the transmit power of the pilot signal to be transmitted to the source using the received power of the pilot signal received from the destination and the channel state information of the source-RS link.

12. The method of claim 9, wherein controlling the transmit power comprises controlling the transmit power of the pilot signal to be transmitted to the source to be equal to the received power of the pilot signal received from the destination.

13. The method of claim 9, wherein transmitting the power-controlled pilot signal comprises:
determining the transmission period of a pilot signal including the channel state information of the source-RS link;
transmitting the pilot signal including the channel state information of the source-RS link at a predetermined power level in every transmission period; and
transmitting the pilot signal including the channel state information of the RS-destination link outside the transmission period.

14. A channel state estimating method in a Relay Station (RS) in a wireless relay network, comprising the steps of:
estimating state of a channel of a source-RS link and a channel of an RS-destination link using pilot signals received from a source and a destination;
monitoring reception of a pilot signal including channel state information of a source-destination link from the source; and
upon receipt of the pilot signal, estimating, a channel of the source-destination link using the pilot signal and the channel state information of the source-destination link.

15. The channel state estimating method of claim 14, wherein estimating the states of the channel of the source-RS link and the channel of the RS-destination link comprises:
measuring the received power of the pilot signals received from the source and the destination;
checking the transmit power of the pilot signals transmitted by the source and the destination; and
estimating the channels of the source-RS link and the RS-destination link using the received power of the pilot signals and the transmit power of the pilot signals.

16. The channel state estimating method of claim 14, wherein monitoring reception of a pilot signal comprises
determining the transmission period of a pilot signal including channel state information of the source-RS link, transmitted by the source;
determining the transmission period of a pilot signal received from the source;
determining that the received pilot signal includes the channel state information of the source-destination link, if the received pilot signal is outside the transmission period of the pilot signal including the channel state information of the source-RS link.

17. The channel state estimating method of claim 14, wherein the pilot signal including the channel state information of the source-destination link has been subject to power-control according to the channel state information of the source-destination link.

18. The channel state estimating method of claim 14, wherein estimating a channel of the source-destination link comprises:
upon receipt of the pilot signal including the channel state information of the source-destination link from the source, measuring the received power of the pilot signal;
determining the transmit power of a pilot signal transmitted from the destination to the source;
estimating the state of the channel of the source-destination link using the received pilot power and the transmit pilot power, if the source has generated the pilot signal using the channel state information of the source-RS link.

19. The channel state estimating method of claim 18, further comprising:
estimating the channel state information of the source-RS link from the received power of the pilot signal, if the source has not generated the pilot signal using the channel state information of the source-RS link; and
estimating the channel of the source-destination link using the power of the pilot signal free of the channel state information of the source-RS link and the transmit power of the pilot signal.

20. An operation method in a source, for channel estimation in a Relay Station (RS) in a wireless relay network, comprising the steps of:
a state of a channel of a source-destination link using a pilot signal received from a destination;
controlling the transmit power of a pilot signal to be transmitted to the RS based on channel state information of the source-destination link; and
transmitting the power-controlled pilot signal to the RS.

21. The operation method of claim 20, wherein estimating the state of the a channel comprises:
measuring the received power of the pilot signal received from the destination;
determining the transmit power of the pilot signal transmitted by the destination; and
estimating the channel of the source-destination link using the received power of the pilot signal and the transmit power of the pilot signal.

22. The operation method of claim 20, wherein controlling the transmit power comprises:
determining channel state information of a source-RS link; and
controlling the transmit power of the pilot signal to be transmitted to the RS using the received power of the pilot signal received from the destination and the channel state information of the source-RS link.

23. The operation method of claim 20, wherein the controlling the transmit power comprises controlling the transmit power of the pilot signal to be transmitted to the RS to be equal to the received power of the pilot signal received from the destination.

24. The operation method of claim 20, wherein the transmitting the power-controlled pilot signal comprises:
determining the transmission period of a pilot signal including the channel state information of the source-RS link;
transmitting the pilot signal including the channel state information of the source-RS link at a predetermined power level in every transmission period; and
transmitting a pilot signal including the channel state information of the source-destination link outside the transmission period.

25. A Relay Station (RS) apparatus for channel estimation in a source in a wireless relay network, comprising;
a pilot signal generator for generating a pilot signal to be transmitted to the source;
a pilot power controller for controlling the transmit power of the pilot signal using channel state information of an RS-destination link;
an encoder for encoding and modulating transmission data for the source at a coding rate and in a modulation scheme; and
a multiplexer for generating a transmission signal by multiplexing the coded and modulated data with the power-controlled pilot signal.

26. The RS apparatus of claim 25, further comprising a receiver for measuring the received power of a pilot signal received from a destination, wherein the pilot power controller controls the transmit power of the pilot signal to be transmitted to the source to be equal to the measured received pilot power.

27. The RS apparatus of claim 26, wherein the pilot power controller controls the transmit power of the pilot signal to be transmitted to the source using the measured received pilot power and channel state information of a source-RS link.

28. A source apparatus for channel estimation in a wireless relay network having Relay Station (RSs), comprising;
a demultiplexer for extracting a pilot signal from a signal received through an antenna; and
a channel estimator for estimating a channel of an RS-destination link using a pilot signal received from an RS.

29. The source apparatus of claim 28, wherein the channel estimator estimates a channel of a source-RS link and a channel of a source-destination link using pilot signals received from the RS and a destination every predetermined period, and, upon receipt of a pilot signal including channel state information of the RS-destination link from the RS, estimating the channel of the RS-destination link using the received power of the pilot signal and the transmit power of a pilot signal transmitted from the destination to the RS.

30. The source apparatus of claim 28, wherein the channel estimator estimates the channel of the source-RS link and the channel of the source-destination link using the pilot signals received from the RS and the destination every predetermined period, and upon receipt of the pilot signal including channel state information of the RS-destination link from the RS, estimating, the channel of the RS-destination link using the received power of the pilot signal, the transmit power of a pilot signal transmitted from the destination to the RS, and the channel state information of the source-RS link.

31. A source apparatus for channel estimation in a Relay Station (RS) in a wireless relay network, comprising;
a pilot signal generator for generating a pilot signal to be transmitted to the RS;
a pilot power controller for controlling the transmit power of the pilot signal using channel state information of a source-destination link;
an encoder for encoding and modulating transmission data for the RS at a coding rate and in a modulation scheme; and
a multiplexer for generating a transmission signal by multiplexing the coded and modulated data with the power-controlled pilot signal.

32. The source apparatus of claim 31, further comprising a receiver for measuring the received power of a pilot signal received from a destination, wherein the pilot power controller controls the transmit power of the pilot signal to be transmitted to the RS to be equal to the measured received pilot power.

33. The source apparatus of claim 32, wherein the pilot power controller controls the transmit power of the pilot signal to be transmitted to the RS using the measured received pilot power and channel state information of a source-RS link.

34. A Relay Station (RS) apparatus for channel estimation in a wireless relay network, comprising;
a demultiplexer for extracting a pilot signal from a signal received through an antenna; and
a channel estimator for estimating a channel of a source-destination link using a pilot signal received from a source.

35. The RS apparatus of claim 34, wherein the channel estimator estimates a channel of a source-RS link and a channel of an RS-destination link using pilot signals received from the source and a destination every predetermined period, and, upon receipt of a pilot signal including channel state information of the source-destination link from the source, estimating the channel of the source-destination link using the received power of the pilot signal and the transmit power of a pilot signal transmitted from the destination to the source.

36. The RS apparatus of claim 34, wherein the channel estimator estimates a channel of a source-RS link and a channel of an RS-destination link using pilot signals received from the source and a destination every predetermined period, and upon receipt of a pilot signal including channel state information of the source-destination link from the source, estimating, the channel of the source-destination link using the received power of the pilot signal, the transmit power of a pilot signal transmitted from the destination to the source, and the channel state information of the source-RS link.
